(19) United States
(12) Patent Application Publication
(10) Pub. No.: US 2024/0406573 A1
(43) Pub. Date: Dec. 5, 2024

(54) VIDEO CAMERA OPTIMIZATIONS BASED ON ENVIRONMENTAL MAPPING

(71) Applicant: APPLE INC., Cupertino, CA (US)

(72) Inventors: Anselm GRUNDHOEFER, Campbell, CA (US); Simon FORTIN-DESCHENES, Santa Clara, CA (US); Christian I. MOORE, Sunnyvale, CA (US); Luke A. PILLANS, San Diego, CA (US); Christophe SEYVE, Saratoga, CA (US); Seyedkoosha MIRHOSSEINI, Santa Clara, CA (US)

(21) Appl. No.: 18/666,948

(22) Filed: May 17, 2024

Related U.S. Application Data
(60) Provisional application No. 63/469,681, filed on May 30, 2023.

(51) Int. Cl. H04N 23/745; H04N 23/71; H04N 23/73

(52) U.S. Cl. CPC H04N 23/745; H04N 23/71; H04N 23/73

(57) ABSTRACT

Various implementations disclosed herein improve the appearance of captured video by accounting for light-based flicker and/or other factors affecting the appearance of video captured by a wearable electronic device. Some implementations are used with head-mounted devices (HMDs) that relay one or more front-facing camera feeds to display panels in front of the user's eyes. Some implementations adjust the exposure of one or more cameras of such a device based on assessing the lighting in the physical environment being captured in images/video by the cameras. Camera exposure may be adjusted (e.g., using discrete levels of exposure that are an even multiple of a light flicker rate) to reduce the appearance of flicker from one or more light sources in the physical environment. Whether and how to adjust exposure to reduce flicker may be based on environmental characteristics corresponding to visibility/objectionability of flicker from one or more light sources.

### CROSS-REFERENCE TO RELATED APPLICATION

This patent application claims the benefit of U.S. Provisional Application No. 63/469,681 filed May 30, 2023, entitled “VIDEO CAMERA OPTIMIZATIONS BASED ON ENVIRONMENTAL MAPPING,” which is incorporated herein by this reference in its entirety.

### TECHNICAL FIELD

The present disclosure generally relates to improving the appearance of video images captured and displayed by electronic devices and more specifically to systems, methods, and devices that adaptively adjust the exposure of video capture to account for light-based flicker, motion-induced blur, noise, or other factors related to video appearance.

### BACKGROUND

One or more light sources within an environment that is being videod can produce flicker within the captured video. Existing techniques may not adequately address such flicker and/or other issues related to the appearance of video captured by electronic devices.

### SUMMARY

Various implementations disclosed herein improve the appearance of captured video by accounting for light-based flicker and/or other factors affecting the appearance of video captured by a wearable electronic device. Some implementations are used with head-mounted devices (HMDs) that relay one or more front-facing camera feeds to display panels in front of the user's eyes to create the illusion that the user is viewing the physical environment directly. Some implementations adjust camera settings and/or other parameters (e.g., exposure settings, gain settings, framerate settings, etc.) to adjust image quality characteristics (e.g., brightness, color, exposure, flicker, tone-mapping, sharpening, noise reduction, motion blur, etc.).

Some implementations adjust the exposure of one or more cameras of such a device based on assessing the lighting in the physical environment being captured in images/video by the cameras. Camera exposure may be adjusted (e.g., using discrete levels of exposure that are an even multiple of a light flicker rate) to reduce the appearance of flicker from one or more light sources in the physical environment. Whether and how to adjust exposure to reduce flicker may be based on environmental characteristics corresponding to visibility/objectionability of flicker from one or more light sources.

Some implementations further account for motion-induced blur in adjusting the exposure, e.g., balancing the appearance of blur that may be present based on device motion with the appearance of flicker that may be present based on the lighting in the physical environment. Some implementations additionally or alternatively account for flicker by changing the frame rate.

In one exemplary implementation, a processor executes instructions stored in a computer-readable medium to perform a method. The method may be performed at a head-mounted device (HMD) having one or more left-eye outward-facing cameras associated with a left-eye viewpoint and one or more right-eye outward-facing cameras associated with a right-eye viewpoint. The method provides pass-through video via the HMD in which video captured via the one or more left-eye outward-facing cameras is presented on a left-eye display to provide an approximately live view of a physical environment from the left-eye viewpoint and video captured via the one or more right-eye outward-facing cameras is presented on a right-eye display to provide the approximately live view of the physical environment from the right-eye viewpoint. The passthrough video(s) may be modified or transformed to account for differences in the cameras' positions and the eye positions. The pass-through video(s) may be provided via a hardware-encoded rendering process that combines images from the cameras with virtual content in views provided to each eye.

The method determines an environment characteristic corresponding to an appearance (e.g., visibility/objectionability) of flicker associated with one or more light sources of the physical environment. The environment characteristic may be include one or more of: (a) whether light sources are producing low or high frequency light; (b) overall environment brightness, time of day, occlusions, and other such visibility-impacting factors; (c) 3D locations of light sources based on current and/or prior sensor data (e.g., a persistent digital map of the environment identifying flicker characteristics of each light source); (d) 3D locations of surfaces based on current and/or prior sensor data; (e) data from a simple/efficient sensor, e.g., a single photodiode (f) user movement (e.g., towards one of several light sources); (g) deciding which of multiple light sources to correct for based on scoring each light source (e.g., w/r/t flicker objectionability); and/or other factors.

Based on the environment characteristic, the method determines an exposure parameter for the pass-through video. This may involve determining to use an exposure length corresponding to a discrete level corresponding to an even multiple of a light flicker rate of one of the light sources. Exposure can be adjusted to balance flicker considerations and blur considerations. Thus, the method may determine an exposure parameter (e.g., maximum exposure, minimum exposure, exposure target value, etc.) based at least in part on the motion of the HMD. In one example, if a user's head is moving quickly, a maximum exposure for current conditions is determined based on a motion curve corresponding to providing a constant blur amount. Such an adjustment may not be applied, and a flicker-based exposure adjustment applied instead, in circumstances identified based on an evaluation of the environment characteristic (e.g., where flicker will be more objectionable than motion-blur).

The method adjusts an exposure of the one or more left-eye outward facing camaras and the one or more right-eye outward-facing cameras based on the determined exposure parameter. For example, given a target exposure length, a maximum exposure value, a minimum exposure value, etc., an exposure value may be determined that is appropriate for the environment characteristics, device motion, and/or other circumstances and conditions. An exposure, in various implementations, may be determined based on factors including, but not limited to, detected motion, detected lighting, gain settings, where a user is looking, display persistence, motion-response lag, system power and processing resources, and other such factors. The method presents the video on the display of the HMD.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory, computer-readable storage medium stores instructions, which, when executed by one or more processors of a device, cause the device to perform or cause performance of any of the methods described herein. In accordance with some implementations, a device includes one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an example of an electronic device used within a physical environment in accordance with some implementations.

FIG. 2 illustrates an example of 3D data generated for the physical environment of FIG. 1 in accordance with some implementations.

FIG. 3 illustrates an exemplary light mapping process in accordance with some implementations.

FIG. 4 is a flowchart illustrating an exemplary method of improving the appearance of video capture to account for environment characteristics in accordance with some implementations.

FIG. 5 illustrates an exemplary device configured in accordance with some implementations.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

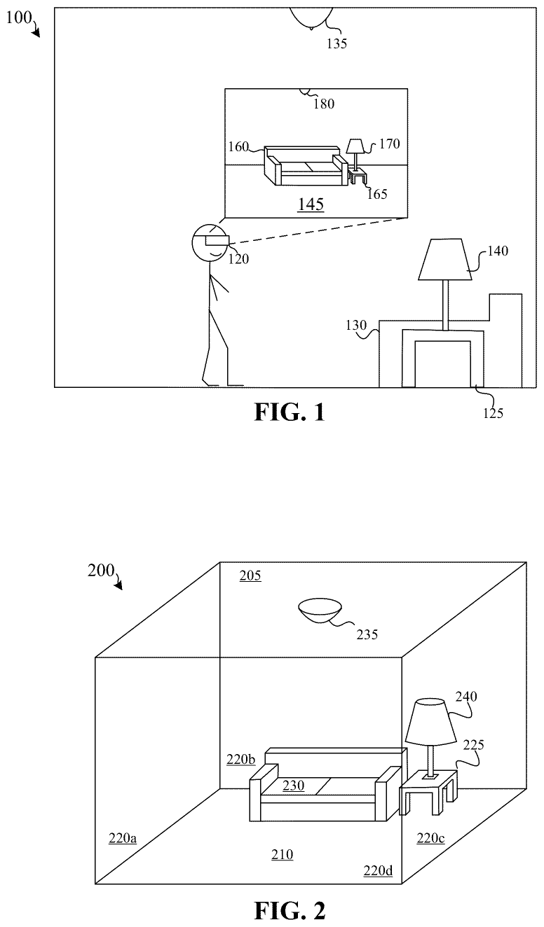

FIG. 1 illustrates an example of an electronic device 120 used by a user within a physical environment 100. A physical environment refers to a physical world that people can interact with and/or sense without the aid of electronic systems. Physical environments, such as a physical park, include physical articles, such as physical trees, physical buildings, and physical people. People can directly sense and/or interact with the physical environment, such as through sight, touch, hearing, taste, and smell. In FIG. 1, the physical environment 100 includes a sofa 130, a table 125, a lamp 140, and an overhead light 135.

In the example of FIG. 1, the electronic device 120 is illustrated as a single device. In some implementations, the electronic device 120 is worn by a user. For example, the electronic device 120 may be a head-mounted device (HMD) as illustrated in FIG. 1. Some implementations of the electronic device 120 are hand-held. For example, the electronic device 120 may be a mobile phone, a tablet, a laptop, and so forth. In some implementations, functions of the electronic device 120 are accomplished via two or more devices, for example, additionally including an optional base station. Other examples include a laptop, desktop, server, or other such devices that includes additional capabilities in terms of power, CPU capabilities, GPU capabilities, storage capabilities, memory capabilities, and the like. The multiple devices that may be used to accomplish the functions of the electronic device 120 may communicate with one another via wired or wireless communications.

Electronic device 120 captures and displays pass-through video of the physical environment 100. In this example, an exemplary frame 145 of the video is captured and displayed at the electronic device 120. The frame 145 (and additional frames) may be captured and displayed in a serial manner, e.g., as part of a sequence of captured frames in the same order in which the frames were captured. In some implementations the frame 145 is displayed approximately simultaneously with its capture, e.g., during a live video feed. In some implementations, the frame 145 is displayed after a latency period or otherwise at a time after the recording of the video. The frame 145 includes a depiction 160 of the sofa 130, a depiction 165 of the table 125, a depiction 170 of the lamp 140, and a depiction 180 of the overhead light 135. One or both of the light sources (e.g., the lamp 140 and the overhead light 135) may be a source of flicker in the pass-through video that is captured. In addition, movement of the device 120 (e.g., as the user rotates their head) may result in motion blur. The exposure of the camera(s) capturing the pass-through video may be adapted to reduce/remove flicker and/or blur, and/or to optimally balance between the appearance of flicker and blur.

In some implementations, an HMD is configured with video pass-through that is enabled to adaptively change exposure times during head movements to minimize perceived motion blur. However, many lights sources, such as LEDs, OLEDs, and LCDs, use frequencies or otherwise produce flicker. A flicker sensor, able to determine a dominant flicker frequency, may be used to adjust the exposure of the flicker in a pass-through video stream. In one example, a dedicated flicker sensor with spatial resolution is used to detect flicker. In other example, flicker in determined based on more general sensor data, e.g., image sensor data, depth sensor data, etc. In mixed lighting situations, a sensor may not pick up the frequency which might generate the strongest flicker and thus the flicker-sensor-based mitigation strategy might be ineffective with respect to reducing the most noticeable/objectionable flicker. Also, if motion blur mitigation (e.g., adjusting exposure to account for motion) is triggered, flicker associated with some of the (suppressed) flickering lights might become observable for a short amount of time while the motion blur suppression is triggered.

Some implementations disclosed herein reduce these and/or other under-desirable appearance attributes. Some implementations determine an environment characteristic (e.g., a 3D mapping of light sources/surfaces in the environment) and use that environment characteristic to adjust exposure to reduce flicker, blur, and/or otherwise improve video appearance. In some implementations, a 3D map such as a SLAM map is generated based on sensor data on an HMD and used to store flicker readings, e.g., data stored as pose anchors in the 3D map. The 3D map may be updated continuously, e.g., with a specific, flexible update rate. Additional data such as time of day, environment brightness, semantic segmentation, floor plan, and/or occlusion understanding may additionally, or alternatively, be used. Environment characteristics, time of day, environment brightness, semantic segmentation, floor plan, occlusion understanding, motion data, and/or any other relevant factors may be used to compute optimum exposure parameters during video capture, e.g., during the provision of pass-through video on an HMD.

In some implementations, whether to compensate for light flicker is based on the flicker rate of one or more light sources. For example, there may be no need or benefit to compensating for flicker below a certain flicker rate. In some implementations, environment characteristics of a physical environment are determined (e.g., a SLAM mapping with light source locations and associated flicker rates) and used to determine if, and how, to adapt exposure to account for flicker. In one example, the environment characteristics identify that there is global low frequency flicker that does not need to be adjusted for and a localized high-frequency flicker that does need to be adjusted for.

Adjusting exposure may be associated with gain changes and/or impact noise reduction and sharpening. In some implementations, a change in exposure (e.g., adding overexposure to compensate for flicker in a bright environment) is performed with a corresponding change to tone mapping and/or sharpening processes to control account for such potential impacts.

In some implementations, environment characteristics are stored persistently. This can be particularly useful in implementations in which sensors provided data from which flicker sources can be detected/localized lack accuracy or otherwise only provide limited data (e.g., single photodetector data) or only provide data occasionally, e.g., based on power and computing resource constraints. In such circumstances, 3D information about an environment can be updated and made more accurate over time as a user uses a device (and/or other devices) in the environment. The data may persist over time and be used in different user sessions occurring at different times and days.

Flicker rates of light sources in a persistent mapping can be adjusted over time, e.g., based on sensor data obtained on occasions when the user is close to the light source or otherwise able to accurately assess the flicker rate. This information can be stored for later use, e.g., for adjusting exposure at later points in time based on the environment. For example, at a later point in time, an HMD may determine its 3D position within the environment and relative to the 3D positions of light sources in a 3D mapping of the environment and, based on the flicker rates determined live or in the 3D mapping, determine whether and how to adapt exposure to account for flicker.

The exposure adaptation may be based on how likely a light source is to provide objectionable flicker in current circumstances, e.g., based on the distance of the light source, its flicker rate, the overall brightness in the environment, the time of day, and/or other factors.

Some implementations enable flicker compensation using a relatively low power flicker sensor (e.g., a single photodiode running at a high frame rate or a small field of view camera scanning the environment when user is still) and persistent environment characteristic data, e.g., a persistent 3D mapping of light sources and/or surfaces in the environment.

Lights source information may be incorporated into environment characteristic data, e.g., a 3D mapping, using various techniques. In one example, images of the physical environment are obtained and assessed to identify bright areas, and those bright areas are processed to identify and assess the characteristics of the light sources within the 3D environment.

In some implementations, a device operates in one or more flicker compensation modes. For example, the device may operate according to a first flicker compensation mode (e.g., based on only live flicker sensor data) until environment characteristic data (e.g., a 3D mapping) is developed, and then operate in a second flicker compensation mode (e.g., based on the 3D mapping and/or live flicker sensor data).

In some implementations, a 3D mapping of a physical environment identifies the 3D locations, shapes, flicker rates, brightness, and/or other attributes of one or more light sources in the physical environment. Flicker attributes may be based on historical, previously-obtained sensor data. In some implementations, a 3D mapping is based on a SLAM process (e.g., a VIO SLAM process) that is executed initially, periodically, and not necessarily updated during an experience in which flicker compensation is provided. The 3D mapping may be updated over time based on flicker sensor data. A 3D mapping may provide a persistent digital map of a physical environment. It may include information about light source locations and attributes, surface locations and attributes, semantic data (e.g., identifying object types, material types, etc.), and/or other information about the environment from which flicker objectionability may be estimated.

In some implementations, based on current conditions, a score for each of one or more light sources in a physical environment is determined and used to determined which (0 or more) of the light sources are providing objectionable flicker that should be adjusted for, e.g., by adjusting exposure. A given light source may be associated with an exposure time/threshold at which flicker is expected to become objectionable to an average observer or to the specific user.

In some implementations, where a user is looking in a pass-through view of a physical environment (e.g., relative to flickering light sources and surfaces) is used to determine if and how to adjust exposure to account for flicker. Flicker adjustment thus may occur in a given environment when the user looks at a first area but not occur in that same environment when the user looks at a second, different area. Similarly, flicker adjustment (for a dim lamp) may occur while an overhead light is off and the overall brightness in the environment is low but may not occur while the overhead light is on and the overall brightness in the environment is high. The overall brightness may decrease the visibility/objectionability of flicker from the lamp.

In some implementations, a user's motion, e.g., head rotation, is assessed in determining how to balance the appearance of flicker and the appearance of blur in pass-through video. For example, with a stationary head (and device), flicker compensation may be performed to account for a flicker light source. However, with a quickly rotating head (and device), such flicker compensation may be unnecessary (given the difficulty in perceiving the flicker while rotating one's head) or outweighed by a requirement to reduce blur, e.g., by adjusting the exposure according to blur reduction parameters. Balancing flicker and blur may also account for other factors. For example, in an environment with striped walls, head motion may result in a lot of objectionable blur (and thus blur reduction may be prioritized over flicker reduction), while in an environment with solid color walls and limited spatial contrast on surfaces, head motion may not result in much objectionable blur (and thus flicker reduction may be prioritized over blur reduction).

Other factors include whether virtual content is added to the pass-through content, e.g., adding a virtual user interface menu or partially opaque virtual content, how content of the physical environment is occluded in the pass-through video, display brightness, e.g., in the area where flicker occurs, weighting metrics that quantify the relative importance of blur and flicker, the size of the physical environment and/or distance of areas in view, the user's current task, the user's preferences with respect to flicker and blur, the exposure capabilities of the device (e.g., whether compensating for a particular flicker or motion is even possible), etc.

FIG. 2 illustrates an example of 3D data generated for the physical environment 100 of FIG. 1. In this example, a 3D mapping 200 of the physical environment 100 is generated based on image, depth, or other sensor data from device 120 (or another device). The 3D mapping 200 includes 3D representations 205, 210, 220a-d of the ceiling, floor, and walls of the physical environment 100. The 3D mapping 200 further includes a 3D representation 225 of table 125, a 3D representation 230 of couch 130, a 3D representation 240 of lamp 140, and a 3D representation 235 of overhead light 135.

The 3D mapping 200 stores information about the 3D locations of light sources (e.g., 3D representation 240 of lamp 140 and 3D representation 235 of overhead light 135) and information about those light sources, e.g., flicker rate, size, shape, bounding-boxed area, light color, light spectral range, brightness, current state (e.g., on, off, dimmed, etc.), type (e.g., window light, lamp, overhead, LED, LCD, OLED, incandescent, shaded, unshaded, diffuse, directed, angle of illumination, cone of illumination, etc.), and/or other attributes. Similarly, the 3D mapping stores information about the non-light surfaces (e.g., 3D representations 205, 210, 220a-d of the ceiling, floor, and walls, 3D representation 225 of table 125, 3D representation 230 of couch 130, etc.) and information about those surfaces, e.g., size, shape, reflectance properties, texture, spatial contrast, etc.

The 3D mapping 200 information is used to determine whether and/or how to adjust the exposure of one or more camera's providing pass-through video to account for flicker and/or otherwise provide an optimal pass-through view. An observation point relative to the light sources and/or surfaces represented in the 3D mapping 200 may be determined and used in such determinations. For example, an observation point may be determined (based on the HMD's position) to be closer to the 3D representation 240 of the lamp 140 than to the 3D representation 235 of the overhead light 135 and the prioritization of the flicker of the lamp 240 prioritized over the flicker of the overhead light 135. In some implementations, a score for each light source is determined based on an observation point and the 3D mapping 200, e.g., based on how objectionable flicker from each light source is expected to be to an observer at the observation point based the environment characteristics represented in the 3D mapping 200. In some implementations device motion relative to light source location is also taken into account, e.g., prioritizing lights sources with respect to which the user is moving closer over light sources with respect to which the user is moving away.

Various implementations disclosed herein improve the appearance of video images captured and displayed by electronic devices. This may involve adaptively adjusting the exposure or other attributes of video capture to account for various factors related to video appearance including, but not limited to, light-based flicker, motion-induced blur, and noise. Some implementations create a more perceptually-stable passthrough video experience across, providing image brightness stability, flicker reduction, and/or color stability. Some implementations, extend 3D VIO/SLAM or other environmental mapping, for example, adding a fourth dimension (time). Multi-modal information can be used to create or update a 3D map, which could be used to information camera/ISP parameters and/or decisions.

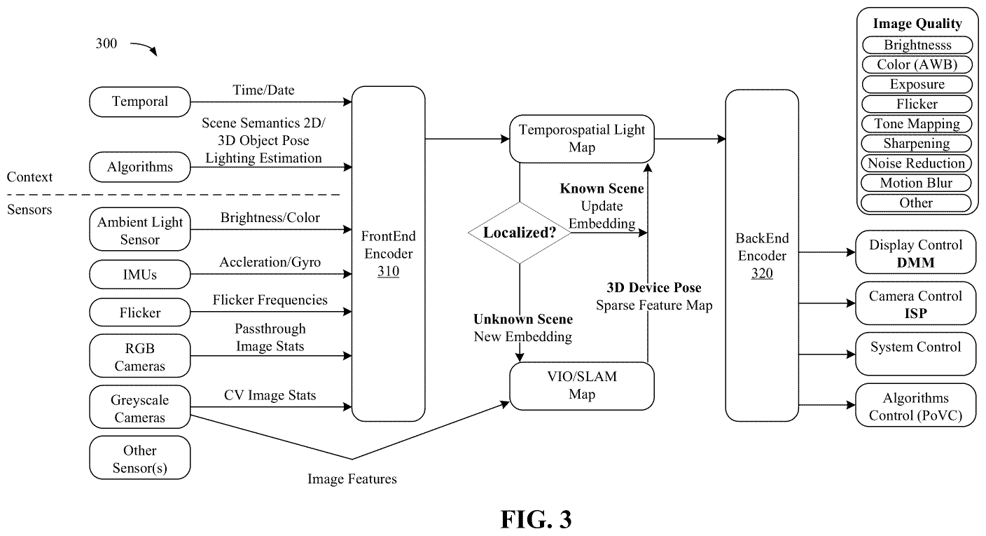

FIG. 3 illustrates an exemplary mapping process. In this example, various context sources and sensor sources provide information to a frontend encoder. A temporal source may provide time/date information. An algorithms source may provide scene semantics, 2D/3D Object pose, and/or lighting estimation. An ambient light sensor (ALS) may provide brightness/color information. One or more IMUs may provide acceleration/gyroscope information. A flicker sensor (or other light) sensor may provide flicker or other light attribute information. An RGB sensor may provide passthrough image data. A greyscale sensor may provide greyscale image data of the environment. The context and sensor-based information is used by the frontend encoder 310 to generate a temporospatial map of the environment.

In the process 300, the temporospatial map is localized. If it corresponds to a known scene, the information is used to update the embedding, e.g., updating an existing map. If corresponds to an unknown scene, a new embedding, sensor information (e.g., greyscale sensor data, etc.) is used for mapping, e.g., VIO/SLAM mapping, and a 3D device pose and/or feature map (e.g., a sparse feature map) may be provided. The temporal light map and related information is provided to the backend encoder 320, which may use the map to for display control, camera control, system control, algorithms control, etc., to address image quality, e.g., brightness, color, exposure, flicker, tone mapping, sharpening, noise reduction, motion blur, etc.

In one example, a user enters a new room and the user's device cannot localize and thus the device operates in a continuous control loop. As the user looks around the room, new lighting observations are added to VIO map (3D Pose Tagged). Once there are enough samples added to light map, the device changes its update control loop (e.g., to use less frequent updates).

In one example, a user enters a room for a second or subsequent time, where the room has an existing light/VIO map. The device uses sensor data to localize into the 3D map (e.g., VIO) and a obtains lighting or other environment information. This may involve looking up the nearest neighboring key pose and looking up lighting observations from that perspective.

A camera control loop may run with additional context to optimize the system, e.g., based on determining that there are existing flicker sources from that perspective.

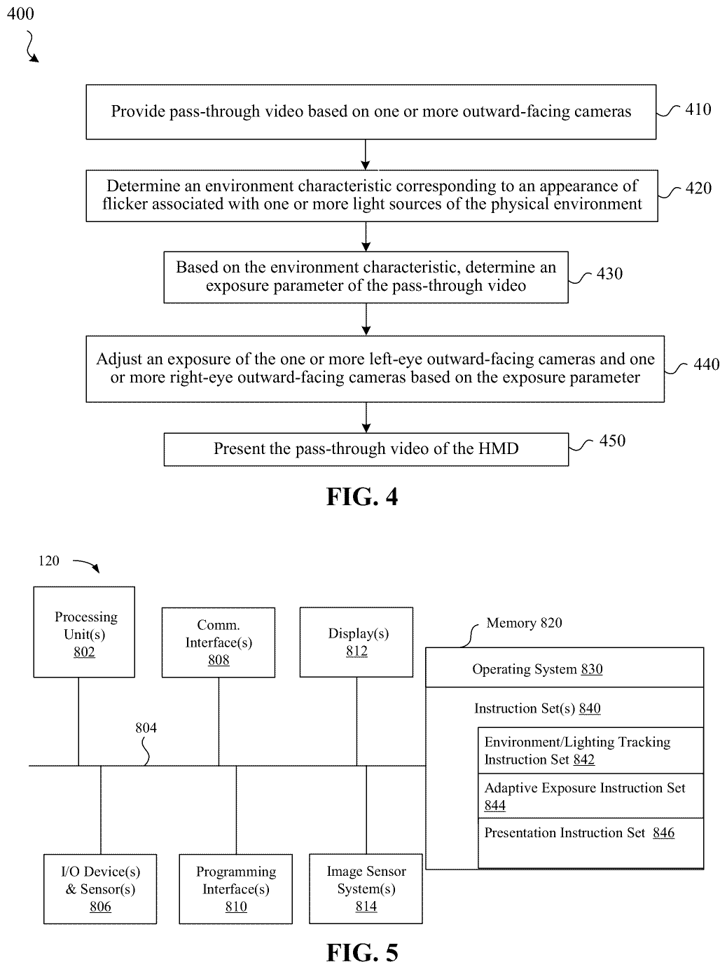

FIG. 4 is a flowchart illustrating an exemplary method 400 of improving the appearance of video capture to account for environment characteristics. In some implementations, the method 400 is performed by a device (e.g., electronic device 120 of FIG. 1). The method 400 can be performed using an electronic device or by multiple devices in communication with one another. In some implementations, the method 400 is performed by processing logic, including hardware, firmware, software, or a combination thereof. In some implementations, the method 400 is performed by a processor executing code stored in a non-transitory computer-readable medium (e.g., a memory).

The method 400 may be performed at a head-mounted device (HMD) having a processor and one or more outward-facing cameras, e.g., one or more left-eye outward-facing cameras associated with a left-eye viewpoint and/or one or more right-eye outward-facing cameras associated with a right-eye viewpoint.

At block 410, the method 400 provides pass-through video in which video captured via one or more outward-facing cameras is presented on one or more displays to provide an approximately live view of a physical environment. This may involve providing video captured via one or more left-eye outward-facing cameras is presented on a left-eye display to provide the approximately live view of the physical environment from a left-eye viewpoint and/or video captured via one or more right-eye outward-facing cameras is presented on a right-eye display to provide the approximately live view of the physical environment from a right-eye viewpoint. The passthrough video(s) may be modified transformed to account for differences in the cameras' positions and the eye positions. The pass-through video(s) may be provided a hardware-encoded rendering process that combines images from the cameras with virtual content in views provided to each eye.

At block 420, the method 400 determines an environment characteristic corresponding to an appearance (e.g., visibility/objectionability) of flicker associated with one or more light sources of the physical environment. The environment characteristic may be include one or more of: (a) whether light sources are producing low or high frequency light; (b) overall environment brightness, time of day, occlusions, and other such visibility-impacting factors; (c) 3D locations of light sources based on current and/or prior sensor data (e.g., a persistent digital map of the environment identifying flicker characteristics of each light source); (d) 3D locations of surfaces based on current and/or prior sensor data; (e) data from a simple/efficient sensor, e.g., a single photodiode (f) user movement (e.g., towards one of several light sources); (g) deciding which of multiple light sources to correct for based on scoring each light source (e.g., w/r/t flicker objectionability); and/or other factors.

In some implementations, the method 400 uses an environment characteristic that is based on whether light sources are producing low or high frequency light, e.g., light below or above a predetermined threshold value. In some implementations, the environment characteristic is based on an overall environment brightness of the physical environment, e.g., whether the overall brightness is above or below a predetermined threshold. In some implementations, the environment characteristic is based on a persistent digital map of the physical environment identifying flicker characteristics of each of the one or more light sources, where the persistent digital map is based on previously-obtained sensor data. The environment characteristic may be based on 3D locations of light sources, e.g., based on live or previously obtained sensor data. The environment characteristic may be based on 3D locations of surfaces of the physical environment based on live or previously-obtained sensor data. The environment characteristic may be based on data from a sensor having a single photodiode. The environment characteristic may be based virtual content to be provided overlaid on the video in a view provided by the wearable electronic device. The environment characteristic may be based on a user movement relative to the one or more light sources. In some implementations, method 400 uses multiple environment characteristics including one or more of those described herein.

Based on the environment characteristic, at block 430, the method 400 determines an exposure parameter for the pass-through video. This may involve determining to use an exposure length corresponding to a discrete level corresponding to an even multiple of a light flicker rate of one of the light sources. Exposure can be adjusted to balance flicker considerations and blur considerations. Thus, the method 400 may determine the exposure parameter (e.g., maximum exposure, minimum exposure, exposure target value, etc.) based at least in part on the motion of the HMD. In one example, if a user's head is moving quickly, a maximum exposure for current conditions is determined based on a motion curve corresponding to providing a constant blur amount. Such an adjustment may not be applied, and a flicker-based exposure adjustment applied instead in circumstances identified based on an evaluation of the environment characteristic (e.g., where flicker will be more objectionable than motion-blur).

An exposure parameter may be determined based on determining that an environment includes a flickering light source. For example, based on identifying that an environment includes a light source producing a 128 Hz flicker (e.g., strobing), an exposure time parameter may require that the exposure selected be a multiple of that period to compensate for the flicker, e.g., using a period of 8.33 ms, 16.66 ms, etc. for a 60 Hz flicker (120 Hz with rectification), using a period of 1.67, 3.33, 5.00, 6.67, 8.33, 10, etc. with a 300 Hz flicker (600 Hz with rectification), etc. A system's frame rate may also provide a maximum/normal exposure period, e.g., with a 90 Hz framerate, a maximum/normal exposure may be 10.2 ms. In some implementations, it may be desirable to reduce the exposure from such a maximum/normal exposure time to a reduced exposure time based on detecting device motion to reduce motion blur, while also accounting for a flickering light source in the environment, e.g., reducing from 10.2 ms to 8.33 ms given a 90 Hz framerate and a 128 Hz light source flicker. In some implementations, blur mitigation via motion-based exposure reduction is entirely disabled in circumstances in which a flickering light source is detected to avoid or reduce the chance or providing noticeable flickering.

The exposure parameter may be determined based on a distance of a portion of a physical environment at which the user is gazing. Distant object may be more likely to include noise and less likely to provide blur and thus reducing exposure may be less appropriate than in circumstances in which the user's gaze is focuses on closer portion of the physical environment. The distance to the object/portion of an environment to which a user is gazing may be determined via eye tracking, e.g., using eye vergence to estimate distance, SLAM to understand the 3D nature of the environment, depth sensor data, and/or using any other suitable distance detection technique.

An exposure parameter may be determined based on information about human motion capabilities, limits, and typical behaviors. An exposure parameter may be based on latency corresponding to time required to identify and respond to the motion. Latency may have a relatively small impact on blur over expected motion trajectories, e.g., given the way that people typically accelerate when turning their heads.

The method 400 may determine the exposure parameter by determining to alter a normal exposure parameter to an exposure selected to reduce flicker. Determining the exposure parameter may involve determining which of multiple light sources in the physical environment to use to select an exposure to reduce flicker. Determining the exposure parameter may involve determining a score for each of the multiple light sources corresponding to flicker objectionability or flicker visibility. Determining the exposure parameter may involve balancing a flicker consideration and a motion-based blur consideration.

At block 440, the method 400 adjusts an exposure of the one or more left-eye outward facing camaras and the one or more right-eye outward-facing cameras based on the determined exposure parameter. For example, given a maximum exposure value, a minimum exposure value, or both, an exposure value may be determined that is appropriate for the environment characteristics, device motion, and/or other circumstances and conditions. An exposure, in various implementations, may be determined based on factors including, but not limited to, detected lighting, 3D light source locations, light attributes, detected motion, gain settings, where a user is looking, display persistence, motion-response lag, system power and processing resources, and other such factors.

The method 400 may additionally or alternatively provide improvement, e.g., correcting for flicker, by changing frame rate, e.g., changing camera exposure time, frequency, and/or phase. In some implementations, the method 400 provides adjustments based on the presence of multiple light sources, for example, by changing both frame rate and the exposure.

At block 450, the method 400 presents the video on the display of the HMD. In some implementations, the method 400 adjusts the exposure of two imaging components, each of the imaging components providing live video to one or two displays of the electronic device.

In some implementations, adaptive exposure is performed for every frame of a video. In some implementations, it is performed periodically, e.g., every other frame, every 5^{th} frame, every 10^{th} frame, etc., and the determined exposure used for intervening frames. In some implementations, adaptive exposure is selectively performed in certain circumstances, e.g., performed when a user is expected to be in a particular environment type (e.g., indoor) but not performed when the user is in other types of environments (e.g., outside).

FIG. 5 is a block diagram illustrating exemplary components of the electronic device 120 configured in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 802 (e.g., DSPs, microprocessors, ASICs, FPGAs, GPUs, CPUs, processing cores, and/or the like), one or more input/output (I/O) devices and sensors 806, one or more communication interfaces 808 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 810, one or more displays 812, one or more interior and/or exterior facing image sensor systems 814, a memory 820, and one or more communication buses 804 for interconnecting these and various other components.

In some implementations, the one or more communication buses 804 include circuitry that interconnects and controls communications between system components. In some implementations, the one or more I/O devices and sensors 806 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 812 are configured to present a view of a physical environment or a graphical environment (e.g., a 3D environment) to the user. In some implementations, the one or more displays 812 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 812 correspond to diffractive, reflective, polarized, holographic, etc. waveguide displays. In one example, the electronic device 120 includes a single display. In another example, the electronic device 120 includes a display for each eye of the user.

In some implementations, the one or more image sensor systems 814 are configured to obtain image data that corresponds to at least a portion of the physical environment 100. For example, the one or more image sensor systems 814 include one or more RGB cameras (e.g., with a complimentary metal-oxide-semiconductor (CMOS) image sensor or a charge-coupled device (CCD) image sensor), monochrome cameras, IR cameras, depth cameras, and/or the like. In various implementations, the one or more image sensor systems 814 further include illumination sources that emit light, such as a flash. In various implementations, the one or more image sensor systems 814 further include an on-camera image signal processor (ISP) configured to execute a plurality of processing operations on the image data. In various implementations, the one or more image sensor systems include an optical image stabilization (OIS) system configured to facilitate optical image stabilization according to one or more of the techniques disclosed herein.

The memory 820 includes high-speed random-access memory, such as DRAM, SRAM, DDR RAM, or other random-access solid-state memory devices. In some implementations, the memory 820 includes non-volatile memory, such as one or more magnetic disk storage devices, optical disk storage devices, flash memory devices, or other non-volatile solid-state storage devices. The memory 820 optionally includes one or more storage devices remotely located from the one or more processing units 802. The memory 820 includes a non-transitory computer readable storage medium.

In some implementations, the memory 820 or the non-transitory computer readable storage medium of the memory 820 stores an optional operating system 830 and one or more instruction set(s) 840. The operating system 830 includes procedures for handling various basic system services and for performing hardware dependent tasks. In some implementations, the instruction set(s) 840 include executable software defined by binary information stored in the form of electrical charge. In some implementations, the instruction set(s) 840 are software that is executable by the one or more processing units 802 to carry out one or more of the techniques described herein.

The instruction set(s) 840 include an environment/lighting tracking instruction set 842, an adaptive exposure instruction set 844, and a presentation instruction set 846. The instruction set(s) 840 may be embodied a single software executable or multiple software executables. In alternative implementations software is replaced by dedicated hardware, e.g., silicon. In some implementations, the environment/lighting tracking instruction set 842 is executable by the processing unit(s) 802 (e.g., a CPU) to create, update, or use a 3D mapping or other environment characteristics as described herein. In some implementations, the adaptive exposure instruction set 844 is executable by the processing unit(s) 802 (e.g., a CPU) to adapt exposure of the one or more cameras of the electronic device 120 to improve image capture as described herein. In some implementations, the presentation instruction set 846 is executable by the processing unit(s) 802 (e.g., a CPU) to present captured video content (e.g., as one or more live video feeds) as described herein. To these ends, in various implementations, these units include instructions and/or logic therefor, and heuristics and metadata therefor.

Although the instruction set(s) 840 are shown as residing on a single device, it should be understood that in other implementations, any combination of the elements may be located in separate computing devices. Moreover, FIG. 4 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations, but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a head-mounted device (HMD) having a processor, one or more outward-facing cameras associated with one or more eye viewpoints:
providing pass-through video via the HMD in which video captured via the one or more outward-facing cameras is presented on one or more displays to provide an approximately live view of a physical environment;
determining an environment characteristic corresponding to an appearance of flicker associated with one or more light sources of the physical environment;
based on the environment characteristic, determining an exposure parameter of the pass-through video; and
adjusting an exposure of the one or more outward-facing cameras based on the determined exposure parameter.

2. The method of claim 1 further comprising presenting the pass-through video of the HMD or recording and storing the pass-through video.

3. The method of claim 1, wherein the environment characteristic is based on whether light sources are producing light with low or high temporal frequency.

4. The method of claim 1, wherein the environment characteristic is based on an overall environment brightness of the physical environment.

5. The method of claim 1, wherein the environment characteristic is based on a time of day.

6. The method of claim 1, wherein the environment characteristic is based on determining that a light source of the physical environment is occluded.

7. The method of claim 1, wherein the environment characteristic is based on a persistent digital map of the physical environment identifying flicker characteristics of each of the one or more light sources, wherein the persistent digital map is based on previously-obtained sensor data.

8. The method of claim 1, wherein the environment characteristic is based on 3D locations of light sources based on live or previously obtained sensor data.

9. The method of claim 1, wherein the environment characteristic is based on 3D locations of surfaces of the physical environment based on live or previously-obtained sensor data.

10. The method of claim 1, wherein the environment characteristic is based on data from a sensor having one or more photodiodes.

11. The method of claim 1, wherein the environment characteristic is based virtual content to be provided overlaid on the video in a view provided by the wearable electronic device.

12. The method of claim 1, wherein the environment characteristic is based on a user movement relative to the one or more light sources.

13. The method of claim 1, wherein determining the exposure parameter comprises determining to alter a normal exposure parameter to an exposure selected to reduce flicker.

14. The method of claim 1, wherein determining the exposure parameter comprises determining which of multiple light sources in the physical environment to use to select an exposure to reduce flicker.

15. The method of claim 14, wherein determining the exposure parameter comprises determining a score for each of the multiple light sources corresponding to flicker objectionability or flicker visibility.

16. The method of claim 1, wherein determining the exposure parameter balances a flicker consideration and a motion-based blur consideration.

17. A head-mounted device (HMD) comprising:
a motion sensor;
a left-eye display;
a right-eye display;
one or more left-eye outward-facing cameras associated with a left-eye viewpoint;
one or more right-eye outward-facing cameras associated with a right-eye viewpoint;
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
providing pass-through video via the HMD in which video captured via the one or more left-eye outward-facing cameras is presented on the left-eye display to provide an approximately live view of a physical environment from the left-eye viewpoint and video captured via the one or more right-eye outward-facing cameras is presented on the right-eye display to provide the approximately live view of the physical environment from the right-eye viewpoint;
determining an environment characteristic corresponding to an appearance of flicker associated with one or more light sources of the physical environment;
based on the environment characteristic, determining an exposure parameter of the pass-through video; and
adjusting an exposure of the one or more left-eye outward-facing cameras and one or more right-eye outward-facing cameras based on the determined exposure parameter.

18. The HMD of claim 17, wherein the environment characteristic is based on whether light sources are producing light with low or high temporal frequency.

19. The HMD of claim 17, wherein the environment characteristic is based on an overall environment brightness of the physical environment.

20. The HMD of claim 17, wherein the environment characteristic is based on a time of day.

21. The HMD of claim 17, wherein the environment characteristic is based on determining that a light source of the physical environment is occluded.

22. The HMD of claim 17, wherein the environment characteristic is based on a persistent digital map of the physical environment identifying flicker characteristics of each of the one or more light sources, wherein the persistent digital map is based on previously-obtained sensor data.

23. The HMD of claim 17, wherein the environment characteristic is based on 3D locations of light sources based on live or previously obtained sensor data.

24. The HMD of claim 17, wherein the environment characteristic is based on 3D locations of surfaces of the physical environment based on live or previously-obtained sensor data.

25. A non-transitory computer-readable storage medium, storing program instructions executable via one or more processors to perform operations comprising:
providing pass-through video in which video captured via one or more left-eye outward-facing cameras is presented on the left-eye display to provide an approximately live view of a physical environment from the left-eye viewpoint and video captured via one or more right-eye outward-facing cameras is presented on the right-eye display to provide the approximately live view of the physical environment from the right-eye viewpoint;
determining an environment characteristic corresponding to an appearance of flicker associated with one or more light sources of the physical environment;
based on the environment characteristic, determining an exposure parameter of the pass-through video; and
adjusting an exposure of the one or more left-eye outward-facing cameras and one or more right-eye outward-facing cameras based on the determined exposure parameter.
